(19) United States
(12) Patent Application Publication
(10) Pub. No.: US 2008/0120957 A1
(43) Pub. Date: May 29, 2008

(54) Roller And Agricultural Machine

(76) Inventors: Didier Delphigue, Dijon (FR); Jean Viaud, Gray (FR)

Correspondence Address: DEERE & COMPANY, ONE JOHN DEERE PLACE, MOLINE, IL, 61265, US

(21) Appl. No.: 11/835,525

(22) Filed: Aug. 8, 2007

(30) Foreign Application Priority Data
Nov. 28, 2006 (DE) 10 2006 056 048.5

(51) Int. Cl. A01D 34/00; A01D 34/40; A01D 39/00

(52) U.S. Cl. 56/500; 492/48; 56/341

(57) ABSTRACT

In an agricultural machine, for example a round baler, rollers are provided. The roller bodies are composed of a stably configured mounting and a casing which can be fastened thereon. This enables the casings to be manufactured more simply and at lower cost.

### FIELD OF THE INVENTION

The intention relates to a roller in an agricultural machine, in particular in a round baler, having a rotary receiving fixture and a roller body, and to an agricultural machine.

### BACKGROUND OF THE INVENTION

Known rollers in round balers have a roller body which is shaped from a thick metal plate. This metal plate is shaped into a tube and is welded together on a peripheral line. Such rollers are profiled to enable them to transport material. A manufacturing process of this kind emerges from DE U 91 13 338.

It is also known to provide supporting elements inside such rollers, see U.S. Pat. No. 4,198,804.

Finally, from, DE 40 19 335 C2, it is known that a roller manufactured in the known manner can have shells mounted onto it, which allow the round baler to be used in specific circumstances.

### SUMMARY OF THE INVENTION

The problem on which the invention is founded can be seen in the fact that the forces acting on the periphery of the roller are so great that the weld seam tears and that the metal plate has to be configured very thick. The thicker the metal plate, the more difficult it is to deform.

This problem is solved by the present invention wherein a roller in an agricultural machine, in particular in a round baler has a rotary receiving fixture and a roller body, wherein the roller body has a mounting and an exchangeable casing.

In this way, the roller body can be assembled from semi-finished products, for example from prefabricated steel tubing, and a relatively thin metal or plastic casing which is easy to produce and is easily adaptable to the respective conditions. The casing can be easily exchanged in case of wear, damage or, if the usage conditions change.

To enable the roller to be easily journaled, configured and installed, its rotary receiving fixture is configured, according to choice, as an axle, shaft or shaft stub, and it supports bearings or is supported by bearings.

It is only important that the mounting absorbs the radially generated loads and is configured strong enough for this purpose. This can be achieved with a simple round tube or a tube of different cross section, or with a welded construction; if this is justifiable in terms of weight and cost, a solid material may also be chosen or a tube can be fill with a filling or supporting agent.

The casing has merely the task of looking after the conveying function, for which reason it has a regular profile, which is formed of sheet metal, plastic or an applicable coating.

Owing to the simple adaptability of the casing according to this invention, casings in a number of variants between any kind of profiling and a smooth surface are conceivable. The profiling may have webs, pyramids, bulges, etc.

A simple assembly/disassembly, of the casing or the mounting is ensured, if the casing is, in particular, welded, bolted, riveted, shrunk, spot-welded or glued onto the mounting.

If the casing is initially configured in flat form and such that it can be unwound onto the periphery of the mounting and fastened there, for example, glued, bolted, or spot-welded, it can be easily exchanged, where necessary.

Instead of forming a whole sheath, the casing can also comprise a plurality of, possibly even different, portions, which are respectively fitted onto the mounting. Where appropriate, in the peripheral surface of the mounting, grooves or the like can be made, into which end regions of the portions are fitted or inserted.

Round balers, especially, but not exclusively, fixed chamber balers bear in their pressing chambers, in the pressing of silage material, round bales weighing close to 1000 kg, the weight of which rests on a few rollers. Particularly when working on a slope and a round baler with a complete round bale is driven down the slope before being unloaded, the forces are very high and persistent. It is therefore extremely advantageous for such round balers to be equipped with inventive rollers of this kind, lighter or conventional rollers being able to be used in locations where no such loads occur. The divided construction of the rollers also allows the use of differently profiled casings, depending on the placement of the roller in the round baler.

In chopping machines having rollers for feeding material to be chopped, the advantage of dividing the roller into a functional and a load-bearing component lies more in the possibility of being able to react faster to wear.

### BRIEF DESCRIPTION OF THE DRAWINGS

An illustrative embodiment of the invention is described in greater detail below with reference to the appended drawing figures wherein:

FIG. 1 shows an agricultural machine in side view, having a plurality of rollers;

FIG. 2 shows a longitudinal section through a roller; and,

FIG. 3 shows a roller in perspective view.

### DESCRIPTION OF THE PREFERRED EMBODIMENT

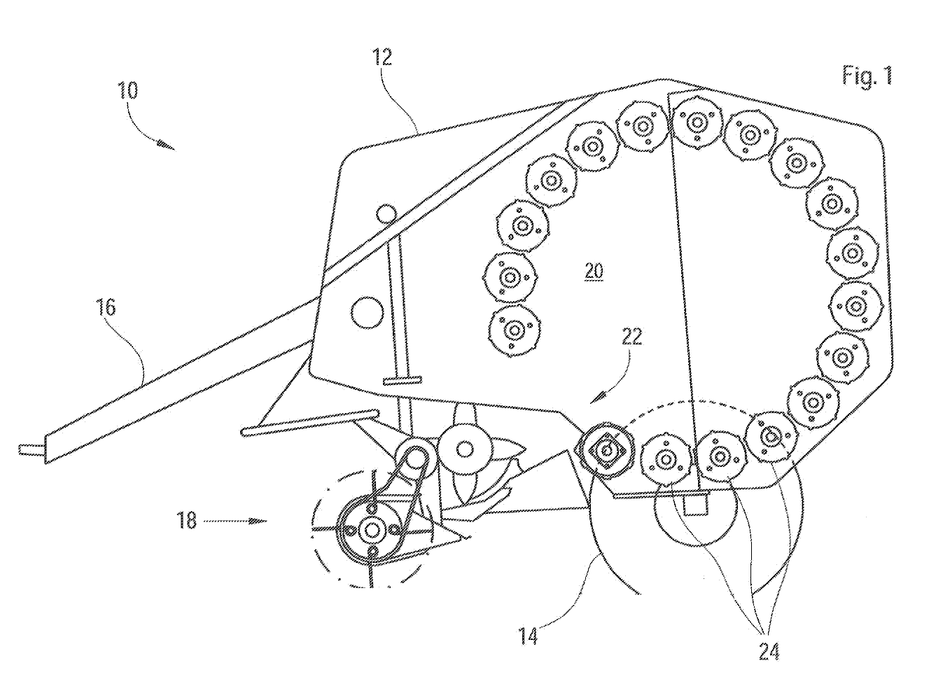

An agricultural machine 10 shown in FIG. 1, in the guise of a round baler in fixed-chamber construction, has, inter alia, a frame 12, wheels 14, a drawbar 16, a pick-up 18, a pressing chamber 20, an inlet 22 into the pressing chamber 20, and rollers 24. Many other components, such as a binding device, are also of course provided, as is usual in round balers.

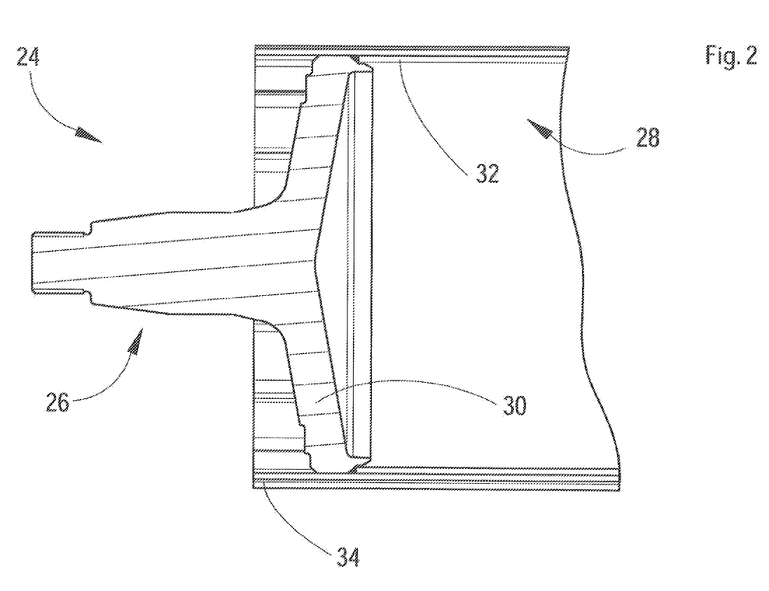

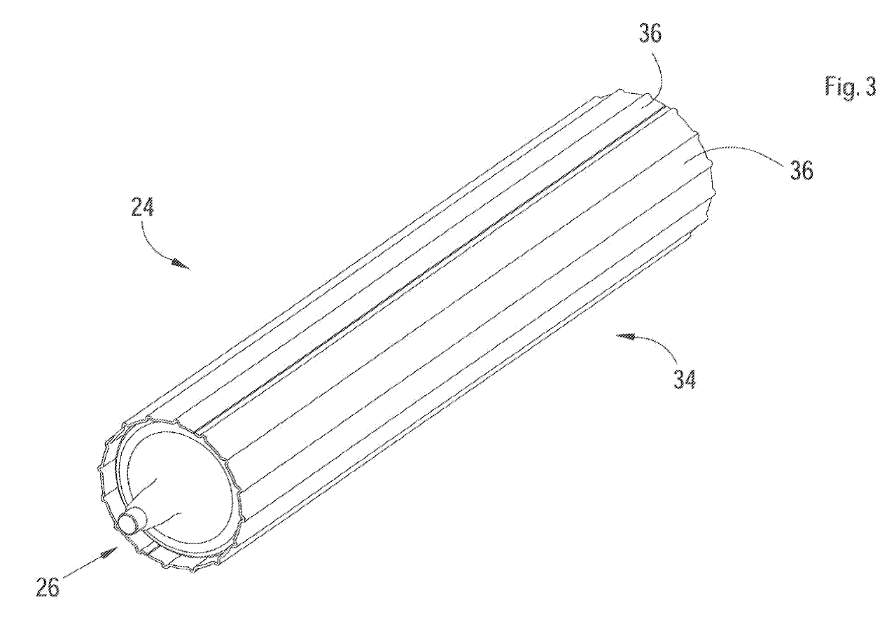

With continued reference to FIG. 1 and also to FIGS. 2 and 3 it can be seen that the rollers 24 are preferably disposed on the floor of the pressing chamber 20 and are formed of a rotary receiving fixture 26 and a roller body 28, which are accommodated in the frame 12 such that they can be conventionally rotated by means of bearings (not shown) and, in part, can also be driven.

The rotary receiving fixtures 26 are configured as shaft stubs having a radial disc 30 made of metal, preferably of cast steel.

The roller bodies 28 are composed of a mounting 32 and a casing 34, which can be fixedly, though preferably detachably, connected to one another. The roller body 28 is welded or bolted to the rotary receiving fixtures 26.

The mounting 32 is configured in this illustrative embodiment as a round steel tube, which can be procured as a semi-finished product.

The casing 34 is formed from a rolled or otherwise profiled relatively thin metal plate, which is in this case prefabricated as a sleeve and is slid axially onto the mounting 32 and fixed by means of small spot welds. In this illustrative embodiment, the casing 34 is configured longer than the mounting 32 and covers a part of the rotary receiving fixture 26. In this case, the casing 34 comprises two identical portions 36, which respectively form half shells and meet along a longitudinal center plane.

If the casing 34 is configured as a sleeve or the like, it is slid with a sliding fit concentrically to and onto the mounting 32.

Having described the preferred embodiment, it will become apparent that various modifications can be made without departing from the scope of the invention as defined in the accompanying claims.

1. A roller in an agricultural machine having a rotary receiving fixture and a roller body wherein the roller body has a mounting and an exchangeable casing.

2. A roller according to claim 1, wherein the rotary receiving fixture is configured as one of: an axle, shaft or shaft stub and is journaled or supports the roller.

3. A roller according to claim 1 wherein the mounting is configured as one of: a tube, a cage or as solid material.

4. A roller according to claim 1 wherein the casing is formed of one of: sheet metal, plastic or a coating.

5. A roller according to claim 1, wherein the casing is one of: a profiled or smooth configuration.

6. A roller according to claim 1 wherein the casing is one of: welded, bolted, riveted, shrunk, or glued onto the mounting.

7. A roller according to claim 1 wherein the casing is configured such that it is flexible in terms of its surface and extends at least substantially over the periphery of the mounting.

8. An agricultural machine having at least one roller having a rotary receiving fixture and a roller body wherein the roller body has a mounting and an exchangeable casing.

9. An agricultural machine according to claim 8, wherein the rotary receiving fixture is configured as one of: an axle, shaft or shaft stub and is journaled or supports the roller.

10. An agricultural machine according to claim 8 wherein the mounting is configured as one of: a tube, a cage or as solid material.

11. An agricultural machine according to claim 8 wherein the casing is formed of one of: sheet metal, plastic or a coating.

12. An agricultural machine according to claim 8, wherein the casing is one of: a profiled or smooth configuration.

13. An agricultural machine according to claim 8 wherein the casing is one of: welded, bolted, riveted, shrunk, or glued onto the mounting.

14. An agricultural machine according to claim 8 wherein the casing is configured such that it is flexible in terms of its surface and extends at least substantially over the periphery of the mounting.

15. An agricultural machine according to claim 8 wherein the agricultural machine is a round baler.

16. An agricultural machine according to claim 8 wherein the agricultural machine is a chopping machine.
